(19) United States
(12) Patent Application Publication
(10) Pub. No.: US 2026/0221682 A1
(43) Pub. Date: Jul. 30, 2026

(54) ELECTRICAL CONNECTOR ASSEMBLY

(71) Applicant: Molex, LLC, Lisle, IL (US)

(72) Inventors: Lin Tong, Dongguan City (CN); Xing-Qiang He, Dongguan City (CN); Xin Wu, Dongguan City (CN)

(21) Appl. No.: 19/457,204

(22) Filed: Jan. 23, 2026

(30) Foreign Application Priority Data
Jan. 24, 2025 (CN) 202510123007.0

(51) Int. Cl. H01R 12/77

(52) U.S. Cl. CPC H01R 12/775

(57) ABSTRACT

An electrical connector assembly is provided and includes an insulative outer housing and a terminal module fixed to the insulative outer housing. The insulative outer housing includes a main body and two locking portions which are respectively provided at two sides of the main body, the two locking portions are used to lock the main body on a substrate. A front end of the main body is formed with a receiving cavity which extends along a longitudinal direction. The terminal module is provided in the rear of the receiving cavity, the terminal module includes a plurality of conductive terminals and a module housing which is used to fix the plurality of conductive terminals. The plurality of conductive terminals protrude into the receiving cavity and are arranged as two rows up and down. A stopping portion extends in the middle of the receiving cavity of the main body along a transverse direction, two ends of the stopping portion are respectively connected to two inner side walls of the receiving cavity. The stopping portion is positioned between the plurality of conductive terminals of the two rows which are arranged up and down, the stopping portion protrudes forwardly relative to the module housing of the terminal module, so that the stopping portion is used to stop a mating board which inserts into the receiving cavity. The electrical connector assembly is capable of retaining firm connection of the terminal module, normal operation of the electrical connector assembly can be maintained.

### TECHNICAL FIELD

The present disclosure relates to field of connector assemblies, and particularly relates to an electrical connector assembly.

### BACKGROUND

Traditionally, as disclosed in CN216389742U, a cable connector includes an insulative housing, a plurality of conductive terminals, a terminal retaining mechanism which is insulative, and a shielding mechanism which is provided in the insulative housing. The plurality of conductive terminals are retained in the insulative housing, each conductive terminal includes a mating portion and a tail portion, the tail portion is configured to be used to be electrically connected with an end portion of a cable, and the mating portion is configured to be used to be electrically connected with a conductive pad of a circuit board. The terminal retaining mechanism is provided in the insulative housing and retains the plurality of conductive terminals. The shielding mechanism is configured to be used to provide shielding for connected positions between the tail portions and the end portions of the cables.

However, when the circuit board inserts into and mates with the cable connector, if a user applies an excessive force to insert the circuit board, the circuit board is prone to push terminal retaining mechanism, the conductive terminal(s) may change in position, which causes the cable connector to be failed, so it needs to be further improved.

### SUMMARY

An object of the present disclosure is to provide an electrical connector assembly which is capable of firmly retaining a terminal module in an insulative outer housing in order to solve the deficiency in the prior art.

In order to solve the above technical problem, the present disclosure employs the following technical solution: an electrical connector assembly comprises an insulative outer housing and a terminal module fixed to the insulative outer housing, the insulative outer housing comprises a main body and two locking portions which are respectively provided at two sides of the main body, the two locking portions are used to lock the main body on a substrate, an interior of the main body is formed with a receiving cavity which extends along a front-rear direction, the terminal module is provided in the rear of the receiving cavity, the terminal module comprises a plurality of conductive terminals and a module housing which is used to fix the plurality of conductive terminals, the plurality of conductive terminals protrude into the receiving cavity and are arranged as two rows up and down; a stopping portion extends in the middle of the receiving cavity of the main body along a transverse direction, two ends of the stopping portion are respectively connected to two inner side walls of the receiving cavity, the stopping portion is positioned between the plurality of conductive terminals of the two rows which are arranged up and down, the stopping portion protrudes forwardly relative to the module housing of the terminal module, so that the stopping portion is used to stop a mating board which inserts into the receiving cavity.

In one of implementing manners, each conductive terminal comprises a mating portion which extends forwardly, a fixing portion which is fixed to the module housing, and a tail portion which extends rearwardly, the mating portion is provided in the receiving cavity and is used to establish electrical connection with the mating board, the stopping portion is positioned behind the mating portion.

In one of implementing manners, a vertical distance between the mating portions of the plurality of conductive terminals of the two rows which are arranged up and down is larger than a height of the stopping portion in an up-down direction.

In one of implementing manners, a front end surface of the module housing is provided with a recessed groove, a rear end of the stopping portion is capable of being received in the recessed groove.

In one of implementing manners, two sides of the module housing which are positioned up and down are provided with several latching protrusions, two side walls of the main body which are positioned up and down are correspondingly provided with several latching holes which correspondingly lock with the latching protrusions.

In one of implementing manners, the stopping portion comprises a bar and strengthening structures which are respectively provided to two ends of the bar, a cross-sectional area of the strengthening structure is larger than a cross-sectional area of the bar.

In one of implementing manners, the strengthening structure is provided with a guiding end which protrudes toward the module housing, the guiding end is used to mate with the recessed groove.

In one of implementing manners, the two locking portions protrude rearwardly from the main body and are spaced apart from each other by an interval, the module housing is positioned between the two locking portions, each locking portion is further mounted with a fastener, the fastener passes through the locking portion so that the fastener is capable of being fastened on the substrate.

In one of implementing manners, the electrical connector assembly further comprises a fixing housing which is provided behind the insulative outer housing, the plurality of conductive terminals are electrically connected with a plurality of cables together, the fixing housing surrounds an outer outside of connected positions between the terminal module and the plurality of cables.

In one of implementing manners, an upper surface of the locking portion is provided with a sinking groove, the fastener is mounted in the sinking groove, an outer periphery of the sinking groove is formed with a boss, the boss is provided thereon with a notch, the fixing housing is provided with snapping protrusions, the snapping protrusion snaps into the corresponding notch.

It can be seen from the above technical solutions, the present disclosure at least has the following advantages and beneficial effects: when the mating board and the electrical connector assembly mate with each other, the acting force that the mating board pushes rearwardly may be transferred to the locking portions of the insulative outer housing via the stopping portion, the acting force is then transferred to the external substrate via the locking portions. Therefore, the terminal module will not be directly subjected to pushing of the mating board, connecting relationship between the terminal module and the insulative outer housing in the electrical connector assembly is firmer, during insertion of the mating board by a user, it may prevent the mating board from rearwardly pushing the terminal module to make the terminal module displaced rearwardly and failed.

### BRIEF DESCRIPTION OF THE DRAWINGS

FIG. 1 is a perspective schematic view that an electrical connector assembly and a mating board will mate with each other in an implementing manner;

FIG. 2 is a perspective schematic view of the electrical connector assembly and the mating board of FIG. 1 viewed from another angle;

FIG. 3 is an exploded view of the electrical connector assembly of FIG. 1;

FIG. 4 is an exploded view of the electrical connector assembly of FIG. 3 viewed from another angle;

FIG. 5 is a structure schematic view of a conductive terminal of FIG. 1;

FIG. 6 is a top view of the electrical connector assembly of FIG. 1;

FIG. 7 is a front view of the electrical connector assembly of FIG. 6;

FIG. 8 is a cross-sectional view of the electrical connector assembly along a line B-B of FIG. 7;

FIG. 9 is a perspective view of an insulative outer housing of FIG. 3;

FIG. 10 is a side view of the electrical connector assembly of FIG. 6;

FIG. 11 is a cross-sectional view of the electrical connector assembly along a line A-A of FIG. 7;

FIG. 12 is a front view of the insulative outer housing of FIG. 9; and

FIG. 13 is a cross-sectional view of the insulative outer housing of along a line C-C of FIG. 12.

Reference numerals are presented as follows.
10 electrical connector assembly
11 insulative outer housing
111 main body
1112 latching hole
112 locking portion
113 receiving cavity
114 through hole
115 fastener
116 gasket
117 sinking groove
118 boss
119 notch
110 stopping portion
1101 bar
1103 strengthening structure
1105 guiding end
12 terminal module
121 conductive terminal
1211 mating portion
1212 tail portion
1213 fixing portion
122 module housing
120 terminal row
123 front portion
124 rear portion
125 recessed groove
126 latching protrusion
13 fixing housing
131 snapping protrusion
132 protruding portion
14 cable
S mating space
20 mating board
21 conductive pad

### DETAILED DESCRIPTION

Typical implementing manners that embody the features and advantages of the present disclosure will be described in detail in the following description. It should be understood that the present disclosure can have various changes in different implementing manners without departing from the scope of the present disclosure, and the description and illustrations therein are essentially for illustration purposes and are not to limit the present disclosure.

In the description of the present disclosure, it should be understood that in the embodiments shown in the drawings, the indication of direction or positional relationship (such as up, down, left, right, front, and rear, etc.) is only for the convenience of describing the present disclosure and simplifying the description, and does not indicate or imply that a device or an element referred to must have a specific orientation, be constructed and operated in the specific orientation. These explanations are appropriate when these elements are in the positions as shown in the drawings. If the description of the position of these elements changes, the indication of these directions will also change accordingly.

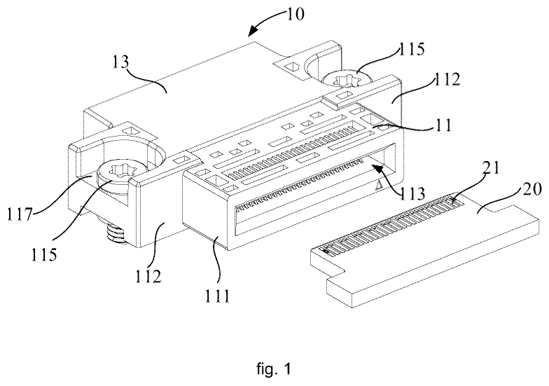

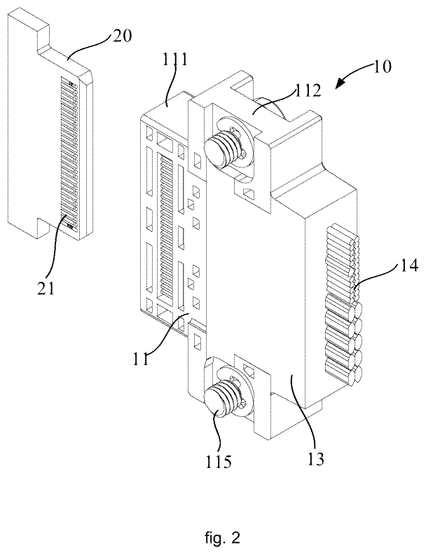

Referring to FIG. 1 and FIG. 2, an electrical connector assembly 10 of the present implementing manner includes an insulative outer housing 11, a terminal module 12 and a cable 14. A front end of the electrical connector assembly 10 may mate with a mating board 20, to transmit data, be connected to a power supply, etc. The terminal module 12 and the cable 14 are electrically connected together. The mating board 20 preferably is a mating circuit board or a mating tongue, the present implementing manner will be described by taking the mating circuit board as example, a front end of the mating board 20 is provided with a conductive pad 21 or a flat plate-shaped conductive terminal (not shown), so that the mating board 20 may insert into the insulative outer housing 11 to establish electrical connection with the terminal module 12 and the cable 14.

The insulative outer housing 11 includes a main body 111 and two locking portions 112 which are respectively provided at two sides of the main body 111. The main body 111 and the two locking portions 112 may be integrally formed by inject molding with a plastic. The insulative outer housing 11 may be formed by an insulative material, an example of the insulative material adapted to form the insulative outer housing 11l includes but is not limited to plastic, nylon, liquid crystalline polymer (LCP), polyphenylene sulfide (PPS), high-temperature nylon, polyphenylene oxide (PPO) or polypropylene (PP).

The main body 111 is an insulative housing in form of square. An interior of the main body 111 is formed with a receiving cavity 113 which extends along a front-rear direction and may allow the mating board 20 to insert therein. A shape of the receiving cavity 113 matches with a shape of the mating board 20. The receiving cavity 113 extends along a longitudinal direction to penetrate the main body 111. For sake of convenient description, it is defined that, in a plane where the mating board 20 is presented, an inserting direction of the mating board 20 is a longitudinal direction, that is, the front-rear direction, a direction perpendicular to the longitudinal direction is a transverse direction, that is, a left-right direction, a direction perpendicular to the plane where the mating board 20 is presented is an up-down direction.

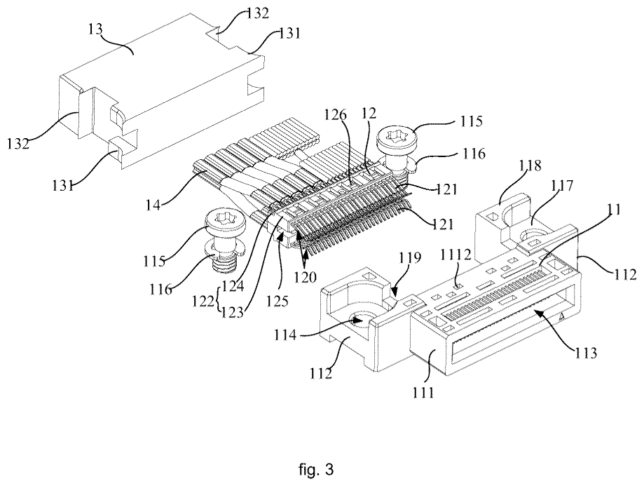

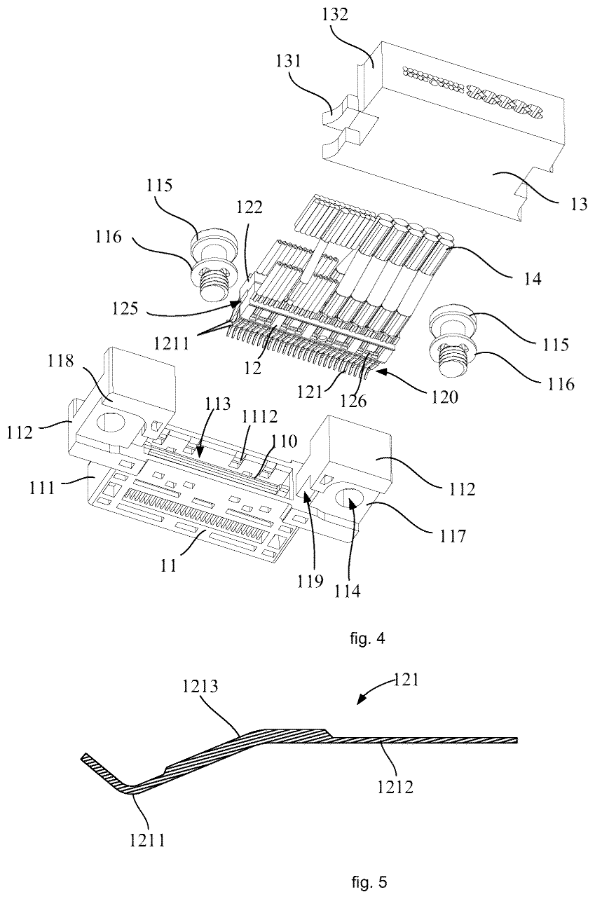

The two locking portions 112 are used to lock the main body 111 on a substrate (not shown). The substrate may be a circuit board or a mounting panel, and the like. Referring to FIG. 3 and FIG. 4, the two locking portions 112 protrude rearwardly from the main body 111 and are spaced apart from each other by an interval, the terminal module 12 is positioned between the two locking portions 112, which may facilitate connection of the terminal module 12 with the main body 111.

The locking portion 112 is provided with a through hole 114. The locking portion 112 is further mounted therein with a fastener 115, the fastener 115 may be a bolt, a screw or a rivet, the present implement manner takes the bolt as example. The fastener 115 passes through the through hole 114 of the locking portion 112 and is fastened on the substrate. The fastener 115 may be further provided thereon with a gasket 116, the gasket 116 is used to disperse a compression force of the bolt and make that the fastener 115 cannot be upwardly released from the locking portion 112.

A mounting direction of the locking portion 112 may be correspondingly designed according to a position where the substrate is provided and a requirement on mounting of the electrical connector assembly 10. That is, the through hole 114 may be provided along the front-rear direction, also may be provided along the up-down direction, here, the mounting direction of the locking portion 112 is not specifically limited.

The terminal module 12 may correspondingly insert forwardly into the insulative outer housing 11 from behind the receiving cavity 113 and may be fixed in the insulative outer housing 11. The receiving cavity 113 is capable of correspondingly receive one terminal module 12. The terminal module 12 includes a plurality of conductive terminals 121 and a module housing 122 which is used to fix the plurality of conductive terminals 121. The plurality of conductive terminals 121 may include a ground terminal, a signal terminal, a power terminal and the like. The conductive terminal 121 may be made from a conductive material, the conductive material may be metal (for example, copper) or metal alloy (for example, copper alloy). The conductive terminal 121 may be formed by stamping.

Meanwhile referring to FIG. 5, the conductive terminal 121 is elongated. Each conductive terminal 121 includes a mating portion 1211, a fixing portion 1213 and a tail portion 1212. The mating portion 1211 is positioned at a front end of the conductive terminal 121, the tail portion 1212 is positioned at a rear end of the conductive terminal 121, and the fixing portion 1213 is positioned in the middle of the conductive terminal 121. The mating portion 1211 and the tail portion 1212 are preferably processed by thinning, so that the mating portion 1211 and the tail portion 1212 each have a thickness thinner than a thickness of the fixing portion 1213. The plurality of conductive terminals 121 are arranged as two rows which are provided to spaced apart from each other up and down, so that the two terminal rows 120 which are positioned up and down are formed. The conductive terminals 121 of the two terminal rows 120 are preferably arranged to be aligned with each other up and down.

The mating portion 1211 of the conductive terminal 121 protrudes forwardly into the receiving cavity 113, the mating portion 1211 is used to establish electrical connection with the conductive pad 21 of the mating board 20. The tail portion 1212 is preferably used to be electrically connected with the cable 14 directly or indirectly, but in some embodiments not shown, the tail portion 1212 also may directly soldered on the substrate. The cable 14 connected with the conductive terminal 121 may be a power cable, a ground cable, a differential signal connecting cable, a high-speed transmitting cable and the like, here, a type of the cable 14 is not specifically limited. The cable 14 and the tail portion 1212 of the conductive terminal 121 are soldered together, the cable 14 also is provided as two rows of cables 14 which face each other up and down, the tail portion 1212 may have better high-speed transmitting characteristics by that the tail portion 1212 is processed by thinning.

Referring to FIG. 3, the module housing 122 is used to fix the plurality of conductive terminals 121 to retain the plurality of conductive terminals 121 as the two terminal rows 120 which are positioned up and down. The fixing portions 1213 of the plurality of conductive terminals 121 are preferably fixed to the module housing 122 by insert molding. The module housing 122 may be formed by an insulative material, an example of the insulative material adapted to form the module housing 122 includes but is not limited to plastic, nylon, liquid crystalline polymer (LCP), polyphenylene sulfide (PPS), high-temperature nylon, polyphenylene oxide (PPO) or polypropylene (PP).

The module housing 122 may be a structure combined by two pieces which are positioned up and down, each piece correspondingly retains the respective terminal row 120. Or, the module housing 122 also may be a single piece integral structure, the two terminal rows 120 directly face each other up and down and are fixed in the module housing 122. The module housing 122 and the plurality of conductive terminals 121 are integrally engaged as the terminal module 12.

The module housing 122 is divided into a front portion 123 and a rear portion 124. The front portion 123 of the module housing 122 is received in the receiving cavity 113, two sides of the front portion 123 of the module housing 122 which are positioned up and down are provided with several latching protrusions 126, two inner side walls of the main body 111 which are positioned up and down are provided with several latching holes 1112 which correspondingly penetrate up and down so as to correspondingly lock with the latching protrusions 126, so that the mating portions 1211 of the plurality of conductive terminals 121 may be fixed in the receiving cavity 113. The rear portion 124 of the module housing 122 is positioned outside the receiving cavity 113, is used to allow the tail portion 1212 of the plurality of the conductive terminals 121 to rearwardly extend out of the rear portion 124 and to be connected with the cables 14.

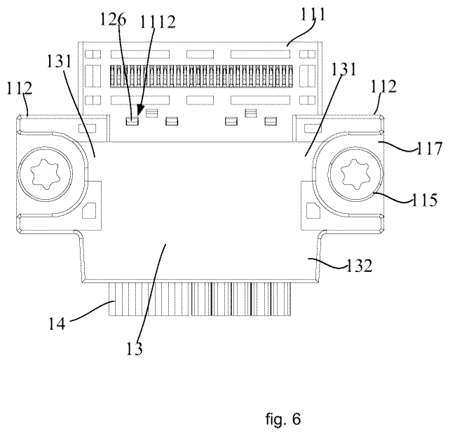

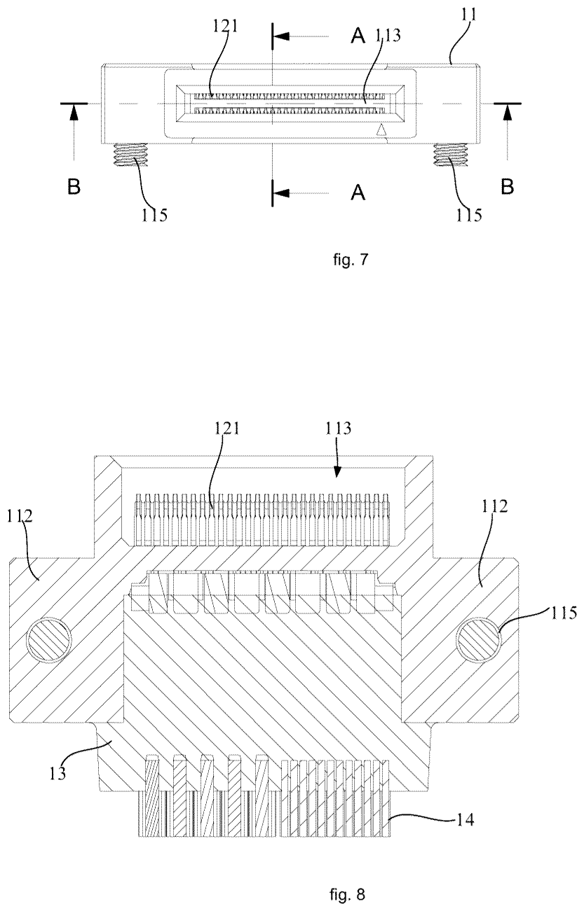

Referring to FIG. 6, FIG. 7 and FIG. 8, specifically, in the present implementing manner, the electrical connector assembly 10 further includes a fixing housing 13 which is provided behind the insulative outer housing 11. The fixing housing 13 surrounds the rear portion 124 of the terminal module 12, specifically, the fixing housing 13 is capable of surrounding the rear portion 124 of the module housing 122 and an outer side of connected positions between the tail portions 1212 of the plurality of conductive terminals 121 and the cables 14, to realize electrical isolation protecting and prevent tensile stress applied to the cables 14 from damaging the connected positions.

The fixing housing 13 may be a plastic housing. The fixing housing 13 may be formed by an insulative material, an example of the insulative material adapted to form the fixing housing 13 includes but is not limited to plastic, nylon, liquid crystalline polymer (LCP), polyphenylene sulfide (PPS), high-temperature nylon, polyphenylene oxide (PPO) or polypropylene (PP).

In other implementing manners, the fixing housing 13 further may be other suitable structure, such as a metal housing and the like, as long as the fixing housing 13 is capable of surrounding the rear portion 124 of the terminal module 12 and realizing fixed connection with the insulative outer housing 11.

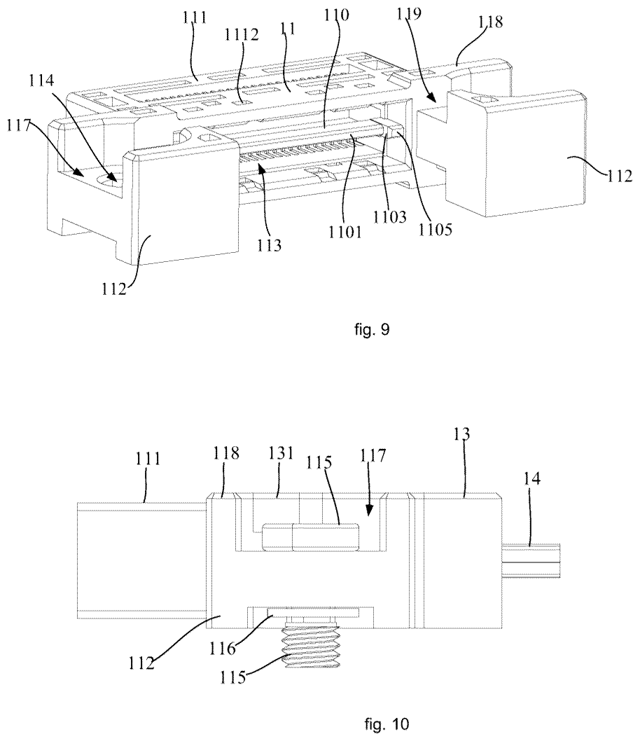

Referring to FIG. 9 and FIG. 10, specifically, in the present implementing manner, an upper surface of the locking portion 112 is provided with a sinking groove 117, a bottom of the sinking groove 117 is provided with the through hole 114. A head of the fastener 115 (the bolt) is received in the sinking groove 117 to avoid the bolt protruding from a surface of the electrical connector assembly 10.

An outer periphery of the sinking groove 117 is formed with a boss 118. An inner side of the boss 118 toward the terminal module 12 is provided with a notch 119. Specifically, the upper surface of the locking portion 112 is preferably provided symmetrically with respect to a lower surface of the locking portion 112. That is, the lower surface of the locking portion 112 also is similarly formed with structures, such as the sinking groove 117, the boss 118, the notch 119 and the like.

Again referring to FIG. 6, two sides of a front end of the fixing housing 13 each are provided with two snapping protrusions 131, the snapping protrusion 131 snaps into the corresponding notch 119. Therefore, the two snapping protrusions 131 of the fixing housing 13 cooperatively snap with the notch 119 of the upper surface of the locking portion 112 and the notch 119 of the lower surface of the locking portion 112 respectively, engagement force between the fixing housing 13 and the locking portion 112 may be enhanced to make the fixing housing 13 and the locking portion 112 firmly connected.

Two sides of a rear end of the fixing housing 13 toward the locking portions 112 each are further provided with a protruding portion 132 which protrudes outwardly. The protruding portion 132 is connected with a rear end surface of the locking portion 112. The protruding portion 132 may seal a gap between the locking portion 112 and the terminal module 12 to assure sealing of the entire electrical connector assembly 10.

Referring to FIG. 11, specifically, in the present implementing manner, in the receiving cavity 113, the mating portions 1211 of the conductive terminals 121 of the two terminal rows 120, which are positioned up and down, therebetween form a mating space S which is used to receive the front end of the mating board 20. And, each mating portion 1211 is substantially bent as a U-shape, a distance between front ends of the mating portions 1211 of the two terminal rows 120 is gradually decreased from front to rear. When the front end of the mating board 20 inserts into the receiving cavity 113 from in front of the main body 111 and enters into the mating space S, the conductive pads 21 of the mating board 20 insert into between the mating portions 1211 of the two terminal rows 120 which are positioned up and down, so that the conductive pads 21 of the mating board 20 contact the mating portions 1211 to realize electrical connection. Due to clamping of the mating portions 1211 of the two terminal rows 120 which are positioned up and down, stable contact between the mating board 20 and the mating portions 1211 can be retained.

Meanwhile referring to FIG. 9, a stopping portion 110 extends in the middle of the receiving cavity 113 of the main body 111 of the insulative outer housing 11 along the transverse direction, two ends of the stopping portion 110 are respectively connected to two inner side walls of the receiving cavity 113. The stopping portion 110 may span the entire receiving cavity 113, and the stopping portion 110 is positioned behind the mating space S, that is, the stopping portion 110 is positioned behind the mating portions 1211 of the two terminal rows 120 which are positioned up and down. The stopping portion 110 protrudes forwardly relative to the module housing 122 of the terminal module 12, so that, after the mating board 20 and the terminal module 12 realize electrical connection therebetween, a front end surface of the mating board 20 will correspondingly abut against the stopping portion 110 while further inserting, an acting force that the mating board 20 pushes rearwardly will be transferred to the locking portions 112 of the insulative outer housing 11 via the stopping portion 110, then will be transferred to the external substrate via the fasteners 115 from the locking portions 112. Because the stopping portion 110 of the insulative outer housing 11 is positioned close to the front relative to the module housing 122, the stopping portion 110 may prevent the mating board 20 from excessively inserting to make the mating board 20 push the module housing 122 of the terminal module 12 to cause the module housing 122 and the conductive terminal(s) 121 fixed on the module housing 122 to be displaced improperly or even be damaged.

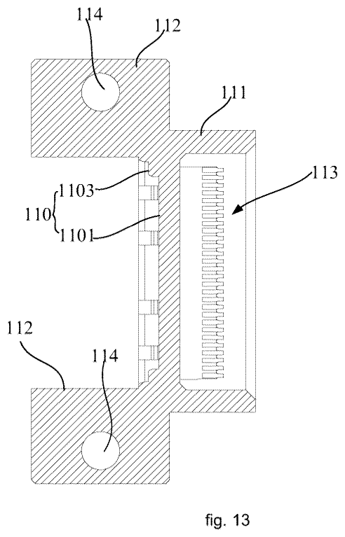

Referring to FIG. 9, FIG. 11 to FIG. 13, specifically, in the present implementing manner, the stopping portion 110 includes a bar 1101 which is elongated and strengthening structures 1103 which are provided to two ends of the bar 1101 respectively, a cross-sectional area of the strengthening structure 1103 is preferably larger than a cross-sectional area of the bar 1101. The bar 1101 spans the receiving cavity 113 along the left-right direction, the strengthening structures 1103 are used to be connected with the two inner side walls of the receiving cavity 113 respectively. That the cross-sectional area of the strengthening structure 1103 is larger may promote connecting strength between the stopping portion 110 and the inner side wall of the main body 111, assure that the stopping portion 110 can withstand pushing of the mating board 20. Specifically, in the present implementing manner, as shown in FIG. 13, the strengthening structure 1103 protrudes rearwardly relative to the bar 1101, a dimension of the strengthening structure 1103 along the front-rear direction substantially is about 1.4 times a dimension of the bar 1101 along the front-rear direction, a height of the strengthening structure 1103 along the up-down direction is slightly larger than a height of the bar 1101 along the up-down direction, the cross-sectional area of the strengthening structure 1103 substantially is about 1.5 times the cross-sectional area of the bar 1101, but in other possible implementing manners, the cross-sectional area of the strengthening structure 1103 may be between 1.3 times and 3 times the cross-sectional area of the bar 1101. In addition, it is noted that, as shown in FIG. 11, although a cross section of the bar 1101 in the present implementing manner is a rectangle which is provided with oblique guiding corners at a rear end thereof, in other possible implementing manners, the cross section of the bar 1101 also may be easily modified as circle, ellipse, triangle, trapezoid, square and the like.

Referring to FIG. 3 and FIG. 4, specifically, in the present implementing manner, a front end surface of the module housing 122 toward the receiving cavity 113 may be further provided with a recessed groove 125. The recessed groove 125 is used to receive a rear half of the stopping portion 110, when the terminal module 12 inserts into the receiving cavity 113, the stopping portion 110 is capable of fitting into the module housing 122 along the recessed groove 125, so that the stopping portion 110 and the module housing 122 cooperate with each other, on one hand, the recessed groove 125 may facilitate positioning of the terminal module 12, on the other hand, the recessed groove 125 may make the terminal module 12 capable of being more stably received in the receiving cavity 113.

Again referring to FIG. 11, when the mating board 20 inserts into the receiving cavity 113 to make the front end of the mating board 20 stopped by the stopping portion 110, the stopping portion 110 and a bottom of the recessed groove 125 preferably further have a gap therebetween, the gap may prevent a pushing force of the mating board 20 from being transferred onto the terminal module 12.

The strengthening structure 1103 is provided with a guiding end 1105 which protrudes rearwardly toward the module housing 122, a rear side of the guiding end 1105 is provided with a guiding surface which extends obliquely, the guiding end 1105 is used to mate with the recessed groove 125. The guiding end 1105 may facilitate mating with the recessed groove 125 of the terminal module 12, and facilitate aligning of the terminal module 12 to enter into the receiving cavity 113.

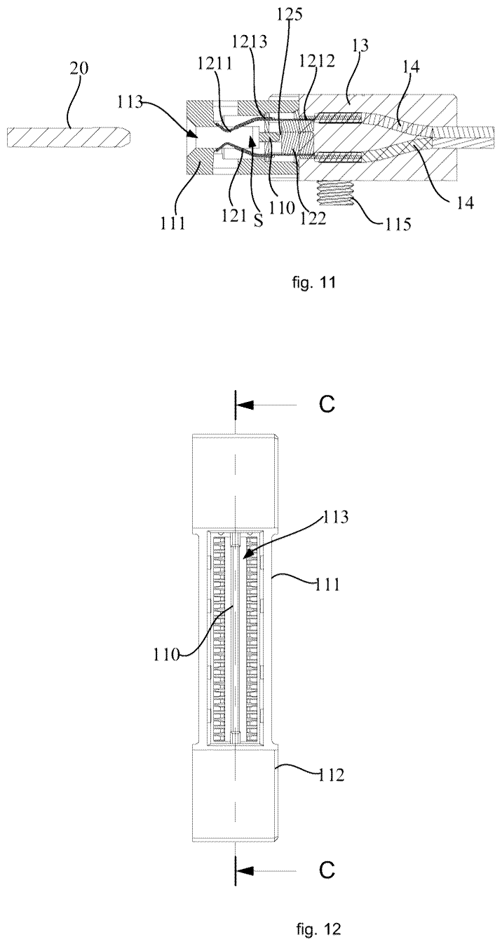

Again referring to FIG. 11 and FIG. 12, in the up-down direction of the receiving cavity 113, the stopping portion 110 is preferably positioned in the middle of the receiving cavity 113 and is positioned between the two terminal rows 120 which are positioned up and down, so as to be convenient to dodge the two terminal rows 120 of the terminal module 12 which insert into the receiving cavity 113 from behind the receiving cavity 113.

And as shown in FIG. 11, the shortest vertical distance between the mating portions 1211 of the two terminal rows 120 which are positioned up and down is preferably larger than a height of the stopping portion 110 along the up-down direction. Specifically, in the present implementing manner, the height of the stopping portion 110 substantially is equivalent to about 70% of the shortest vertical distance of between the mating portions 1211 of the two terminal rows 120 which are positioned up and down, but in other possible implementing manners, the height of the stopping portion 110 may be provided to be between 50%-90% of the shortest vertical distance between the mating portions 1211 of the two terminal rows 120 which are positioned up and down. As shown in FIG. 9, preferably, two sides of a rear end of the stopping portion 110 (the bar 1101 and the strengthening structures 1103) which are positioned up and down each are further provided with a guiding surface which extends obliquely, so that, when the terminal module 12 inserts into the receiving cavity 113 from behind the main body 111, it may avoid the mating portions 1211 of the conductive terminals 121 of the terminal module 12 interfering with the stopping portion 110, facilitate smooth insertion of the conductive terminals 121 into the receiving cavity 113 and prevent the stopping portion 110 and the mating portion 1211 of the conductive terminal 121 from colliding to cause to be improperly bent.

In the present disclosure, when the mating board 20 and the electrical connector assembly 10 mate with each other, the acting force that the mating board 20 pushes rearwardly may be transferred to the locking portions 112 of the insulative outer housing 11 via the stopping portion 110, the acting force is then transferred to the external substrate via the locking portions 112. Therefore, the terminal module 12 will not be directly subjected to pushing of the mating board 20, connecting relationship between the terminal module 12 and the insulative outer housing 11 in the electrical connector assembly 10 is firmer, during insertion of the mating board 20, it may prevent the mating board 20 from rearwardly pushing the terminal module 12 to make the terminal module 12 move rearwardly to affect normal operation of the electrical connector assembly 10.

Although the present disclosure has been described with reference to several typical implementing manners, it should be understood that the terms used are not used as limiting but are illustrative and exemplary. As the present disclosure can be embodied in various forms without departing from the spirit or essence of the present disclosure, it should be understood that the above implementing manners are not limited to any of the aforementioned details, but should be broadly interpreted within the spirit and scope defined by the appended claims. Therefore, all changes and modifications falling within the scope of the claims or equivalent thereof should be covered by the appended claims.

What is claimed is:

1. An electrical connector assembly, comprising an insulative outer housing and a terminal module fixed to the insulative outer housing,
the insulative outer housing comprising a main body and two locking portions which are respectively provided at two sides of the main body, the two locking portions being used to lock the main body on a substrate, an interior of the main body being formed with a receiving cavity which extends along a front-rear direction,
the terminal module being provided in the rear of the receiving cavity, the terminal module comprising a plurality of conductive terminals and a module housing which is used to fix the plurality of conductive terminals, the plurality of conductive terminals protruding into the receiving cavity and being arranged as two rows up and down;
a stopping portion extending in the middle of the receiving cavity of the main body along a transverse direction, two ends of the stopping portion being respectively connected to two inner side walls of the receiving cavity, the stopping portion being positioned between the plurality of conductive terminals of the two rows which are arranged up and down, the stopping portion protruding forwardly relative to the module housing of the terminal module, so that the stopping portion is used to stop a mating board which inserts into the receiving cavity.

2. The electrical connector assembly according to claim 1, wherein
each conductive terminal comprises a mating portion which extends forwardly, a fixing portion which is fixed to the module housing, and a tail portion which extends rearwardly, the mating portion is provided in the receiving cavity and is used to establish electrical connection with the mating board,
the stopping portion is positioned behind the mating portion.

3. The electrical connector assembly according to claim 2, wherein
a vertical distance between the mating portions of the plurality of conductive terminals of the two rows which are arranged up and down is larger than a height of the stopping portion in an up-down direction.

4. The electrical connector assembly according to claim 1, wherein
a front end surface of the module housing is provided with a recessed groove,
a rear end of the stopping portion is capable of being received in the recessed groove.

5. The electrical connector assembly according to claim 1, wherein
two sides of the module housing which are positioned up and down are provided with several latching protrusions,
two side walls of the main body which are positioned up and down are correspondingly provided with several latching holes which correspondingly lock with the latching protrusions.

6. The electrical connector assembly according to claim 4, wherein
the stopping portion comprises a bar and strengthening structures which are respectively provided to two ends of the bar,
a cross-sectional area of the strengthening structure is larger than a cross-sectional area of the bar.

7. The electrical connector assembly according to claim 6, wherein
the strengthening structure is provided with a guiding end which protrudes toward the module housing, the guiding end is used to mate with the recessed groove.

8. The electrical connector assembly according to claim 1, wherein
the two locking portions protrude rearwardly from the main body and are spaced apart from each other by an interval,
the module housing is positioned between the two locking portions,
each locking portion is further mounted with a fastener, the fastener passes through the locking portion so that the fastener is capable of being fastened on the substrate.

9. The electrical connector assembly according to claim 8, wherein
the electrical connector assembly further comprises a fixing housing which is provided behind the insulative outer housing,
the plurality of conductive terminals are electrically connected with a plurality of cables together,
the fixing housing surrounds an outer side of connected positions between the terminal module and the plurality of cables.

10. The electrical connector assembly according to claim 9, wherein
an upper surface of the locking portion is provided with a sinking groove, the fastener is mounted in the sinking groove, an outer periphery of the sinking groove is formed with a boss, the boss is provided thereon with a notch,
the fixing housing is provided with snapping protrusions, the snapping protrusion snaps into the corresponding notch.
